(19) United States
(12) Patent Application Publication
(10) Pub. No.: US 2012/0222782 A1
(43) Pub. Date: Sep. 6, 2012

(54) METHOD FOR FORMING Cu WIRING

(75) Inventors: Atsushi Gomi, Nirasaki-shi (JP); Yasushi Mizusawa, Nirasaki-shi (JP); Tatsuo Hatano, Nirasaki-shi (JP); Osamu Yokoyama, Nirasaki-shi (JP); Tadahiro Ishizaka, Nirasaki-shi (JP); Chiaki Yasumuro, Nirasaki-shi (JP); Takara Kato, Nirasaki-shi (JP)

(73) Assignee: TOKYO ELECTRON LIMITED, Tokyo (JP)

(21) Appl. No.: 13/496,714

(22) PCT Filed: Aug. 27, 2010
(86) PCT No.: PCT/JP10/64588

§ 371 Date: May 24, 2012

(30) Foreign Application Priority Data
Sep. 18, 2009 (JP) 2009-216740

(51) Int. Cl. C21D 1/26; B05D 5/12; B05D 3/02

(52) U.S. Cl. 148/537

(57) ABSTRACT

In a Cu wiring forming method which is followed by a post-process including a treatment of a temperature of 500° C. or higher, an adhesion film made of a metal having a lattice spacing that differs from the lattice spacing of Cu by 10% or less is formed on a substrate having a trench and/or a hole in the surface such that the adhesion film is deposited on at least the bottom and side surfaces of the trench and/or hole. A Cu film is formed on the adhesion film to fill the trench and/or hole. An annealing process is performed on the substrate on which the Cu film has been formed at 350° C. or higher. The CU film is polished to leave only the part of the Cu film which corresponds to the trench and/or hole. A cap is formed on the polished Cu film to form a Cu wiring.

### FIELD OF THE INVENTION

The present invention relates to a copper (Cu) wiring forming method.

### BACKGROUND OF THE INVENTION

Recently, as miniaturization of wiring patterns of semiconductor devices progresses, a demand for a wiring material having a low resistance is increasing due to a problem such as RC delay of wiring or the like. Therefore, Cu having a lower resistance than a conventional wiring material such as Al or W has been adopted.

As for a Cu wiring forming method, there is known a method including the steps of: forming a barrier film made of Ta, TaN, Ti or the like on an interlayer insulating film having a trench or a hole by PVD (physical vapor deposition) represented by sputtering; forming a Cu seed film thereon by PVD; and forming a Cu-plated film thereon to fill the trench or the hole and obtaining a Cu wiring (e.g., Japanese Patent Application Publication No. H11-340226).

In a manufacturing process of a memory device having a cross-point structure, or between wiring processes, or in a next process of a wiring process, a high-temperature treatment at about 500° C. or higher may be needed. However, when the Cu wiring formed by the above-described method is subjected to the high-temperature treatment, Cu agglomeration occurs due to migration of Cu, and a void is formed in the wiring. Further, the resistance of the wiring is remarkably increased. Thus, when the treatment at a high-temperature of about 500° C. or higher is needed after the wiring is formed, W having a high resistance is used in view of thermal stability.

Even when the high-temperature treatment is needed, it is required to use the Cu wiring because the problem of the RC delay is not solved.

### SUMMARY OF THE INVENTION

In view of the above, the present invention provides a Cu wiring forming method which can be used when a treatment with a high-temperature of about 500° C. or higher is performed after a wiring is formed.

In accordance with an aspect of the present invention, there is provided a Cu wiring forming method which is followed by a post-process including a treatment at a temperature of about 500° C. or higher. The method includes forming an adhesion film made of a metal having a lattice spacing which differs from a lattice spacing of Cu by about 10% or less on a substrate having a trench and/or a hole on a surface thereof such that the adhesion film is deposited on at least a bottom and side surfaces of the trench and/or the hole; forming a Cu film on the adhesion film to fill the trench and/or the hole; performing an annealing process on the substrate on which the Cu film has been formed at a temperature of about 350° C. or higher; polishing the CU film to leave only the part of the Cu film which corresponds to the trench and/or the hole; and forming a cap on the polished Cu film to form a Cu wiring.

### BRIEF DESCRIPTION OF THE DRAWINGS

FIG. 1 is a flowchart of a method in accordance with an embodiment of the present invention.

FIGS. 2A to 2H are cross sectional views of the method which is described in FIG. 1.

FIG. 3 shows a relationship between an annealing temperature and a relative resistance change ratio of a Cu film having a thickness of about 10 nm when a Ru film and a Ta film are used as an adhesion film.

FIG. 4 shows a relationship between an annealing temperature and a relative resistance change ratio of a Cu film having a thickness of about 20 nm when a Ru film and a Ta film are used as an adhesion film.

FIG. 5 is an SEM image showing a state of a Cu film when a Cu film having a thickness of about 50 nm is formed on a Ru film having a thickness of about 3 nm.

FIG. 6 is an SEM image showing a state of a Cu film when the Cu film having a thickness of about 50 nm is formed on a Ru film having a thickness of about 3 nm and then annealing is performed in an Ar atmosphere at about 650° C. for about 30 minutes.

FIG. 7 is an SEM image showing a state of a Cu film when the Cu film having a thickness of about 50 nm is formed on a Ru film having a thickness of about 3 nm, and a Ru film having a thickness of about 3 nm is formed thereon, and then annealing is performed in an Ar atmosphere at about 650° C. for about 30 min.

### DETAILED DESCRIPTION OF THE EMBODIMENTS

Hereinafter, an embodiment of the present invention will be described with reference to the accompanying drawings which form a part hereof.

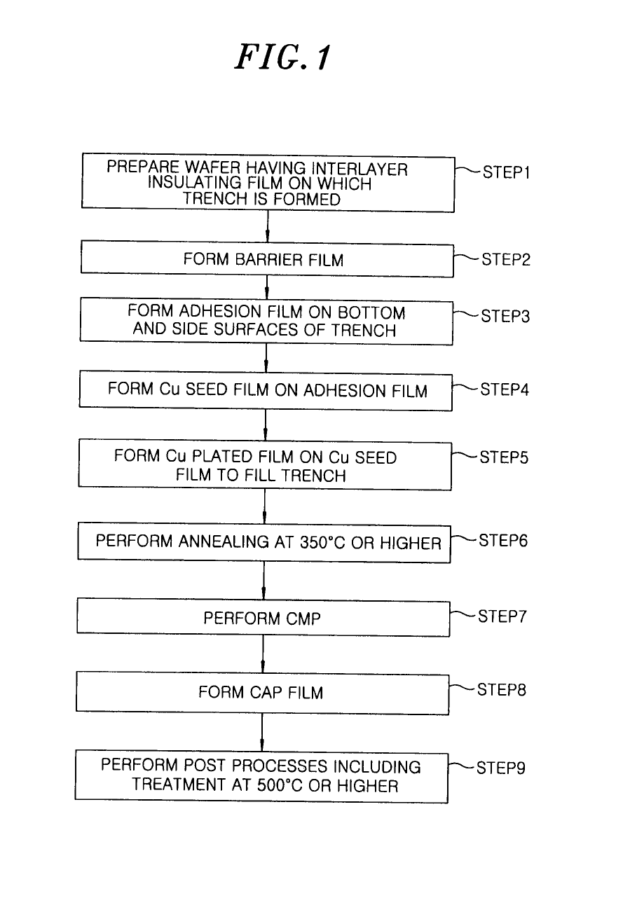

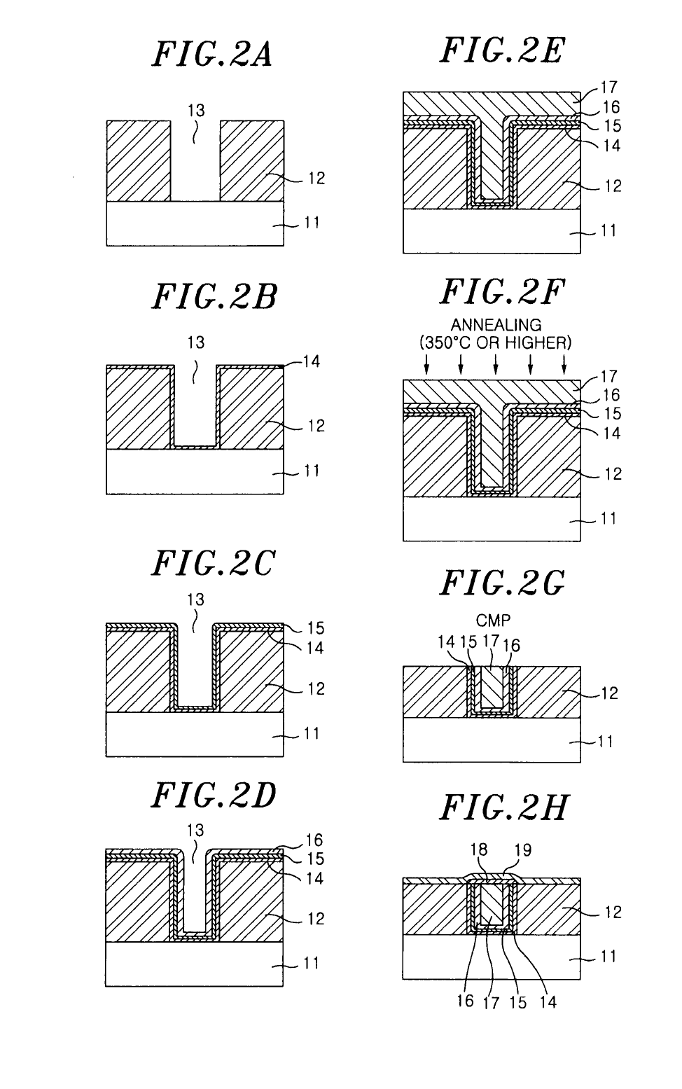

FIG. 1 is a flowchart for explaining a semiconductor device manufacturing process including a Cu wiring forming method in accordance with an embodiment of the present invention. FIGS. 2A to 2H are cross sectional views thereof.

First, a semiconductor wafer (hereinafter, simply referred to as a “wafer”) in which an interlayer insulating film 12, e.g., a SiO₂ film or the like, is formed on an Si substrate 11 and a trench 13 is formed on the interlayer insulating layer 12 is prepared (step 1, FIG. 2A). Next, a barrier film 14 is formed of, e.g., TaN, Ti or the like with a thickness in a range from 1 to 10 nm, e.g., about 4 nm, on the entire surface of the interlayer insulating layer 12 including the trench 13 (step 2, FIG. 2B). At this time, the film formation may be performed by PVD such as sputtering or the like.

Then, an adhesion film 15 having a thickness in a range from 1 nm to 5 nm, e.g., about 4 nm, is formed on at least a bottom surface and side surfaces of the trench 13 (step 3, FIG. 2C). The adhesion film 15 serves to ensure an adhesivity to a Cu film to be formed thereon. As for the adhesion film 15, there is used a metal film having a lattice spacing that differs from a lattice spacing of Cu by about 10% or less. Such metals include V, Cr, Fe, Co, Ni Mo, Ru, Rh, Pd, W, Re, Os, Ir, and Pt. A metal having a lattice spacing which is different from the lattice spacing of Cu by about 5% or less is preferably used as the adhesion film 15. Such metals include Fe, Co, Ni, Ru, Rh, and Os. Crystal structures, lattice constants, Miller indices, lattice spacings of main metals, and their mismatch (%) with a lattice spacing of Cu are shown in Table 1.

TABLE 1

| | | | | | | | | | Lattice | Mismatch |
|---|---|---|---|---|---|---|---|---|---|---|
| Atomic | | Crystal | Lattice constant (Å) | | | Miller indices | | | spacing (Å) | with lattice |
| number | Metal | structure | a | C | c/a | h | k | l | d | spacing of Cu |
| 22 | Ti | hcp | 2.95 | 4.686 | 1.5885 | 0 | 0 | 2 | 2.343 | 12% |
| 23 | V | bcc | 3.0399 | | | 1 | 1 | 0 | 2.150 | 3% |
| 24 | Cr | bcc | 2.8845 | | | 1 | 1 | 0 | 2.040 | −2% |
| 25 | Mn | bcc | 8.894 | | | 1 | 1 | 0 | 6.289 | 201% |
| 26 | Fe | bcc | 2.866 | | | 1 | 1 | 0 | 2.027 | −3% |
| 27 | Co | hcp | 2.502 | 4.061 | 1.6231 | 0 | 0 | 2 | 2.031 | −3% |
| 27 | Co | fcc | 3.537 | | | 1 | 1 | 1 | 2.042 | −2% |
| 28 | Ni | fcc | 3.524 | | | 1 | 1 | 1 | 2.035 | −3% |
| 29 | Cu | fcc | 3.615 | | | 1 | 1 | 1 | 2.087 | — |
| 30 | Zn | hcp | 2.665 | 4.947 | 1.8563 | 0 | 0 | 2 | 2.474 | 19% |
| 40 | Zr | hcp | 3.232 | 5.147 | 1.5925 | 0 | 0 | 2 | 2.574 | 23% |
| 42 | Mo | bcc | 3.147 | | | 1 | 1 | 0 | 2.225 | 7% |
| 44 | Ru | hcp | 2.706 | 4.282 | 1.5824 | 0 | 0 | 2 | 2.141 | 3% |
| 45 | Rh | fcc | 3.803 | | | 1 | 1 | 1 | 2.196 | 5% |
| 46 | Pd | fcc | 3.8898 | | | 1 | 1 | 1 | 2.246 | 8% |
| 47 | Ag | fcc | 4.086 | | | 1 | 1 | 1 | 2.359 | 13% |
| 72 | Hf | hcp | 3.1967 | 5.0578 | 1.5822 | 0 | 0 | 2 | 2.529 | 21% |
| 73 | Ta | bcc | 3.3058 | | | 1 | 1 | 0 | 2.338 | 12% |
| 74 | W | bcc | 3.1648 | | | 1 | 1 | 0 | 2.238 | 7% |
| 75 | Re | hcp | 2.76 | 4.458 | 1.6152 | 0 | 0 | 2 | 2.229 | 7% |
| 76 | Os | hcp | 2.743 | 4.3197 | 1.5748 | 0 | 0 | 2 | 2.160 | 3% |
| 77 | Ir | fcc | 3.839 | | | 1 | 1 | 1 | 2.216 | 6% |
| 78 | Pt | fcc | 3.9231 | | | 1 | 1 | 1 | 2.265 | 9% |
| 79 | Au | fcc | 4.0786 | | | 1 | 1 | 1 | 2.355 | 13% |

By using the adhesion film 15 formed of a metal having a lattice spacing similar to a lattice spacing of Cu, the adhesivity to the Cu film formed thereon is improved. The adhesion film 15 may be formed either by PVD or CVD. Since, however, the adhesion film 15 needs to be formed on a bottom surface and side surfaces of a fine trench, it is preferably formed by CVD which ensures good step coverage. Therefore, it is preferable to employ a metal which has a lattice spacing similar to that of Cu and can be deposited by CVD. Such metal may be Ru. Ru has a lattice spacing that differs from a lattice spacing of Cu by about 3%. Ru can be subjected to the film formation by CVD using as a film forming material an organic metal compound such as ruthenium pentadienyl compound or ruthenium carbonyl (Ru₃(CO)₁₂).

Next, a Cu seed film 16 having a thickness in a range from 5 nm to 50 nm, e.g., about 20 nm, is formed on the adhesion film 15 (step 4, FIG. 2D). The Cu seed film 16 may be formed either by PVD or CVD. Thereafter, a Cu-plated film 17 is formed on the Cu seed film 16 by electroplating, to fill the trench 13 (step 5, FIG. 2E).

At this time, the Cu seed film 16 and the Cu-plated film 17 constitute a Cu film. The adhesion film 15 having a good adhesivity is formed under the Cu film, and the adhesion film 15 is formed on the bottom surface and the side surfaces of the trench 13. Thus, the Cu film in the trench 13 is confined with a good adhesivity at the side surfaces and the bottom surface thereof in a high migration resistance.

Then, the wafer in which the Cu-plated film 17 has been formed is annealed at a temperature of about 350° C. or higher (step 6, FIG. 2F). Through the annealing process, Cu crystal grains grow to have a large diameter so that the resistance of the Cu film is decreased. At this time, the adhesion film 15 has been formed on the side surfaces and the bottom surface of the trench 13 under the Cu film as described above, so that the Cu film has been formed with a high adhesivity. Further, Cu migration hardly occurs even when the annealing is performed at a high temperature of about 350° C. or higher. Therefore, Cu agglomeration caused by Cu migration also hardly occurs, and thus a void is hardly formed in the Cu film.

A maximum temperature of the annealing process at about 350° C. or higher is not particularly limited, and a melting point of Cu becomes an actual maximum temperature thereof. However, when the temperature is excessively high, the grain size increasing effect is saturated, and a void may be formed. Accordingly, the temperature of the annealing process is preferably set within the range from about 350° C. to 800° C.

The annealing process is preferably performed in an atmosphere of an inert gas such as Ar gas, N₂ gas or the like. Alternatively, the annealing process may be performed in an atmosphere of a reduction gas such as hydrogen or the like.

Upon completion of the annealing process at a high temperature, a CMP (Chemical Mechanical Polishing) process is performed to leave only the part of the Cu film which corresponds to the trench (step 7, FIG. 2G). Next, a cap formation is performed (step 8, FIG. 2H) to form a Cu wiring made of a Cu film. In the cap formation step, as in the case of the adhesion film 15, an adhesion film 18 made of a metal having a lattice spacing that differs from a lattice spacing of Cu by about 10% or less is formed as a metal cap on the Cu seed film 16 and the Cu-plated film 17 which have been subjected to the CMP process and, then, a cap film 19 made of an insulating material such as SiCN or the like is formed on the entire surface of the adhesion film 18.

Thus, the adhesion film 18 and the cap film 19 serve as a cap having a two-layer structure. Since the adhesion film 18 has a good adhesivity to the Cu film as in the case of the adhesion film 15, migration resistance of Cu can be further increased. Accordingly, it is possible to suppress a void from being formed in the Cu film in a later step in which a treatment at a temperature of about 500° C. is performed. However, the formation of the adhesion film 18 is not necessary, and the cap film 19 may be directly formed after the CMP process.

After the cap formation step, a series of post-processes including a treatment at a temperature of about 500° C. are carried out (step 9), thereby manufacturing a semiconductor device having a Cu wiring. Specifically, a memory device having a cross-point structure in which a Cu wiring is formed is manufactured by a series of processes including a treatment at a temperature of, e.g., about 750° C.

In the present embodiment, before the Cu seed film is formed, the adhesion film 15 made of a metal having a lattice spacing that differs from a lattice spacing of Cu by about 10% or less is formed on at least the bottom surface and the side surfaces of the trench 13. Therefore, Cu is confined with a good adhesivity at the side surfaces and the bottom surface thereof.

Accordingly, after the Cu-plated film 17 is formed, migration of the Cu film constituted of the Cu seed film 16 and the Cu-plated film 17 is suppressed. Further, even when heating is performed at a high temperature after the Cu film is formed, Cu agglomeration caused by migration and formation of a void in the Cu film are suppressed. By performing an annealing process at a high temperature of about 350° C. or higher in that state, Cu crystal grains can grow to have a large diameter while suppressing migration, and the resistance of the Cu film can be decreased without formation of a void.

Further, by performing the annealing process before a later step, when the treatment of a temperature of about 500° C. or higher is performed in the later step, Cu migration or Cu grain growth is suppressed, and thus the Cu wiring having a low resistance can be obtained without formation of a void.

When the adhesion film 15 is formed only on the bottom surface of the trench 13, the migration of Cu cannot be sufficiently suppressed and, thus, a void is formed in the Cu film during the annealing process of the Cu film. Further, if the annealing process is not performed after the Cu film is formed, a heating process of about 500° C. or higher is performed first on the Cu wiring surrounded by the insulating cap film, so that Cu crystal grains grow and the confined Cu is moved by the grain growth, which may result in formation of a void.

On the other hand, in the preset embodiment, the adhesion film 15 is formed on least at the bottom surface and the side surfaces of the trench 13, and the Cu seed film is formed thereon as described above. Further, the annealing process is performed at about 350° C. or higher after the Cu plating process. Therefore, in a semiconductor device manufacturing process, even if a treatment at a temperature of about 500° C. is carried out after a Cu wiring is formed, the property of the Cu wiring can be maintained while effectively preventing formation of voids caused by Cu agglomeration due to Cu migration and by Cu grain growth.

Especially, with respect to the cap, the adhesion film is also formed such that the entire surface of the Cu film constituting Cu wiring is surrounded by the adhesion film having a good adhesivity. Hence, migration of Cu can be further suppressed, and thus Cu wiring having a low resistance can be more effectively obtained while preventing formation of a void.

Hereinafter, the result of the test for examining the effect of the present invention will be described.

Here, wafers in which a SiO₂ film is formed on a silicon substrate were prepared. Then, a sample (sample A) was obtained by forming in-situ a TaN film as a barrier film having a thickness of about 4 nm, forming a Ru film having a thickness of about 2 nm thereon, forming a Cu film having a thickness of about 10 nm thereon, and forming a Ta film having a thickness of about 2 nm thereon. A sample (sample B) was obtained by forming a Ru film having a thickness of about 2 nm instead of the Ta film in the sample A.

For comparison, a sample (sample C) was obtained by forming a TaN film having a thickness of about 4 nm, forming a Ta film having a thickness of about 2 nm thereon, forming a Cu film having a thickness of about 10 nm thereon, and forming a Ta film having a thickness of about 2 nm thereon. In addition, samples (samples D, E and F) in which the thickness of the Cu film in the samples A to C was changed to about 20 nm were obtained. After an annealing process was performed on the samples A to F in an Ar atmosphere at about 150° C., 350° C. and 650° C. for about 30 minutes, the resistance of the Cu film was measured. In this test, a solid film was used, and the barrier film 14, the adhesion film 15 and the Cu films 16 and 17, and the adhesion film 18 were laminated in the trench in that order from the bottom.

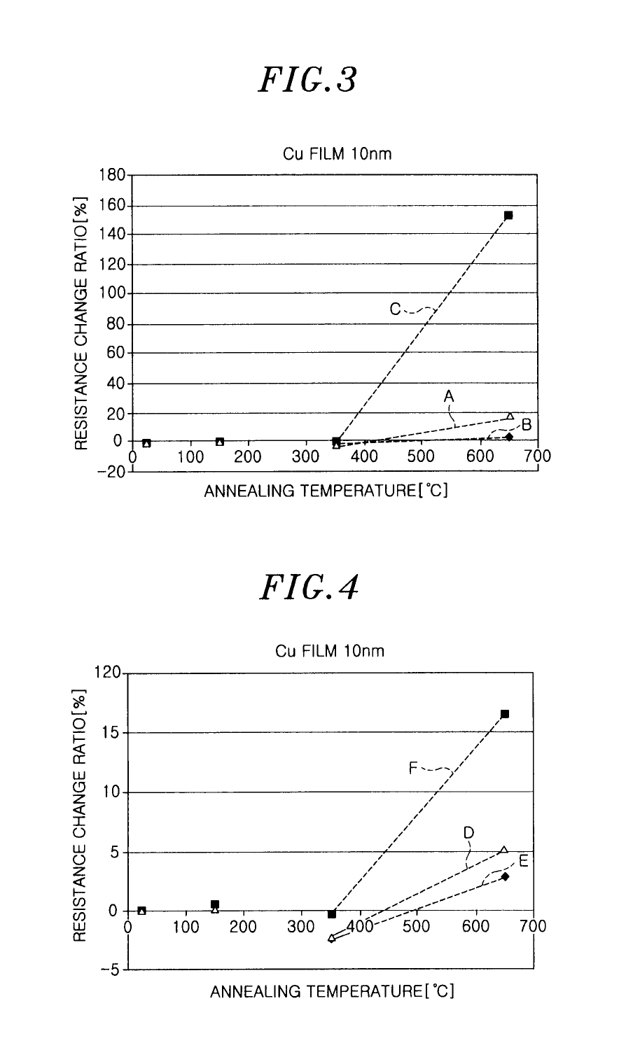

FIGS. 3 and 4 show a relationship between an annealing temperature and a relative resistance change ratio of a Cu film. FIG. 3 shows the case in which the Cu film has a thickness of about 10 nm, and FIG. 4 shows the case in which the Cu film has a thickness of about 20 nm. As can be seen from FIGS. 3 and 4, in the samples C and F in which opposite surfaces of the Cu film were positioned adjoining the respective Ta films, the resistance of the Cu film was extremely increased when the annealing temperature reached about 650° C. On the other hand, in the samples A, B, D and E in which at least one surface of the Cu film was positioned adjoining the Ru film having a lattice spacing similar to a lattice spacing of Cu, the increase rate of the resistance was slowed even if the annealing temperature was increased. Especially, in the samples B and E in which the Cu film was disposed between the Ru films, the increase rate of the resistance was further slowed.

Next, a sample G was obtained by forming as a barrier film a Ti film having a thickness of about 4 nm on the SiO₂ film formed on the silicon substrate, forming a Ru film having a thickness of about 3 nm as an adhesion film thereon, and forming a Cu film having a thickness of about 50 nm thereon. Further, a sample H in which a Ru film having a thickness of about 3 nm was further formed on the Cu film of the sample G was obtained. The samples G and H were subjected to annealing for about 30 minutes at a temperature of about 650° C. in an Ar atmosphere. FIGS. 5 to 7 show SEM images of an as-deposited sample and the samples G and H.

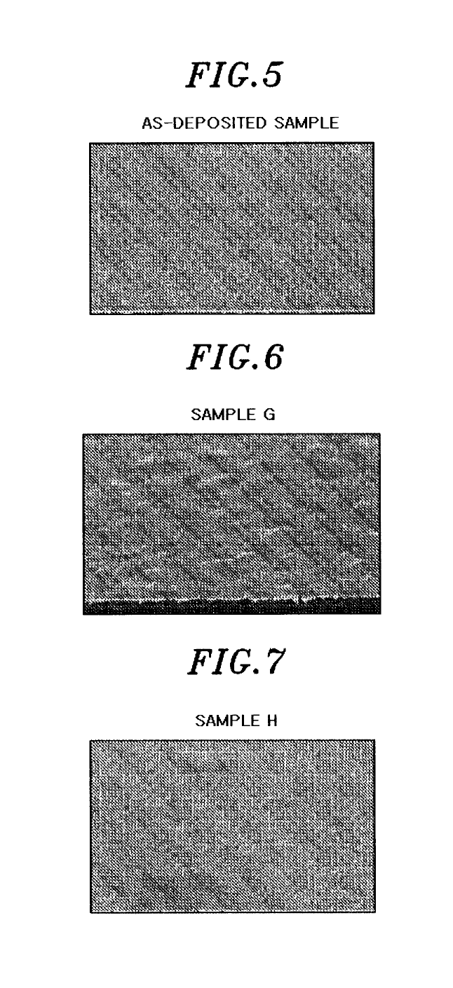

In the sample G in which the Cu film was formed on the Ru film as shown in FIG. 6, grains grew compared to the as-deposited sample shown in FIG. 5 and Cu agglomeration was not shown. Further, in the sample H in which the Ru film is formed as a cap as shown in FIG. 7, the grain growth was shown, and Cu agglomeration was not shown.

Next, the Ru/Cu adhesivity of the sample having a laminated structure in which a Cu film (thickness of about 100 nm) and a Ru film (thickness of about 2 nm) were examined by a four point bending test. As a result, the adhesion strength of about 24J/m² or higher was measured. That is, the high adhesivity was obtained.

From the above, it is clear that, when the adhesion film made of Ru having a lattice spacing that differs from a lattice spacing of Cu by about 10% or less is formed as an underlying film of the Cu film, the Cu film is formed with a high adhesivity, and thus Cu agglomeration (formation of a void) does not occur in spite of the annealing process.

As described above, an adhesion film made of a metal having a lattice spacing that differs from a lattice spacing of Cu by about 10% or less is formed on at least the bottom surface and the side surfaces of the trench and/or the hole before the formation of the Cu film. Therefore, the Cu film is confined with a good adhesivity at the side surfaces and the bottom surface thereof. Accordingly, the migration of the Cu film is suppressed, Cu agglomeration caused by migration and formation of a void in the Cu film are suppressed even when heating is performed at a high temperature after the Cu film is formed.

In addition, by performing the annealing process at a high temperature of about 350° C. or higher in that state, Cu crystal grins can grow to have a large diameter while suppressing migration, and thus the resistance of the Cu film can be reduced without formation of a void. Further, by performing the annealing process in advance, when the treatment at a temperature of about 500° C. or higher is performed in the later step, Cu migration or Cu grain growth is suppressed, and thus the Cu wiring having a low resistance can be obtained without formation a void.

While the present invention has been shown and described with respect to the embodiment, the present invention can be variously modified without being limited to the above embodiments. For example, in the above embodiment, the case in which the Ru film is used as the adhesion film is taken as an example. However, any film made of a metal having a lattice spacing that differs from a lattice spacing of Cu by about 10% or less may be used. Especially, any film made of a metal having a lattice spacing that differs from a lattice spacing of Cu by about 5% or less may be preferably used.

In the above embodiment, the case in which the adhesion film is formed on the wafer having the trench formed thereon and the Cu film is formed thereon is taken as an example. However, in the case of a wafer having a hole formed thereon or a wafer having a trench and a hole thereon, it is possible to obtain the same effect.

In the above embodiment, although the case in which the Cu seed film is formed on the adhesion film, and then the Cu-plated film is formed thereon is taken as an example, the present invention is not limited thereto. For example, the entire Cu film may be formed by CVD.

What is claimed is:

1. A Cu wiring forming method which is followed by a post-process including a treatment at a temperature of about 500° C. or higher, the method comprising:
forming an adhesion film made of a metal having a lattice spacing which differs from a lattice spacing of Cu by about 10% or less on a substrate having a trench and/or a hole on a surface thereof such that the adhesion film is deposited on at least a bottom and side surfaces of the trench and/or the hole;
forming a Cu film on the adhesion film to fill the trench and/or the hole;
performing an annealing process on the substrate on which the Cu film has been formed at a temperature of about 350° C. or higher;
polishing the Cu film to leave only the part of the Cu film which corresponds to the trench and/or the hole; and
forming a cap on the polished Cu film to form a Cu wiring.

2. The Cu wiring forming method of claim 1, wherein the metal forming the adhesion film has a lattice spacing which differs from a lattice spacing of Cu by about 5% or less.

3. The Cu wiring forming method of claim 2, wherein the adhesion film is a Ru film, and the Ru film is formed by CVD.

4. The Cu wiring forming method of claim 1, wherein, when the Cu film is formed, a Cu seed film is formed and, then, Cu plating is performed on the Cu seed film.

5. The Cu wiring forming method of claim 1, wherein, when the cap is formed, an adhesion film made of a metal having a lattice spacing which differs from a lattice spacing of Cu by about 10% or less is formed on the Cu film and a cap film made of an insulating material is formed thereon.

6. The Cu wiring forming method of claim 1, further comprising, prior to the forming of the adhesion film on at least the bottom surface and the side surfaces of the trench and/or the hole in the substrate, forming a barrier film thereon.
